(19) United States
(12) Patent Application Publication
(10) Pub. No.: US 2026/0314608 A1
(43) Pub. Date: Oct. 15, 2026

(54) CONFECTIONS FREE OF ALLERGENS AND METHODS OF MAKING THE SAME

(71) Applicant: JMA Chocolates LLC, Las Vegas, NV (US)

(72) Inventor: Jean-Marie Auboine, Las Vegas, NV (US)

(21) Appl. No.: 19/543,539

(22) Filed: Feb. 18, 2026

Related U.S. Application Data
(60) Provisional application No. 63/760,229, filed on Feb. 19, 2025.

(51) Int. Cl. A21D 13/066; A21D 2/18; A21D 2/26; A21D 8/06; A21D 13/32; A21D 13/47

(52) U.S. Cl. CPC A21D 13/066; A21D 2/181; A21D 2/186; A21D 2/264; A21D 8/06; A21D 13/32; A21D 13/47

(57) ABSTRACT

The present disclosure provides confections that are free of allergens. In several embodiments, the confections comprise a cookie, such as a macaron. In several embodiments, the confection is made without use of nut-derived or nut-based flour. In several embodiments, the confection is made without the use of egg-derived ingredients, such as egg yolk or egg white. In several embodiments, the confections are both allergen and gluten-free.

### RELATED APPLICATION DATA

This application claims priority to U.S. Provisional Application Ser. No. 63/760,229, filed Feb. 19, 2025, which is incorporated by reference in its entirety herein.

### FIELD

This application relates to confections that are substantially free of allergens and/or substantially free of gluten. Embodiments of the confections provided for herein are therefore available to a wider audience of consumers. In several embodiments, the confection comprises a cookie. In several embodiments, the confection is a macaron.

### BACKGROUND

Nut allergies (such as tree nuts) and allergens in general are a point of interest in the food industry. Growing numbers of consumers have sensitivity to allergens in general. Many consumers have allergies to tree nuts (or products derived from tree nuts) and can exhibit adverse responses even to small or trace amounts of tree nut derived substances (e.g., those resulting from cross-contamination in a multi-product food production facility). Additionally, many consumers are sensitive to gluten or derivatives thereof. There is a need for allergen and/or gluten-free confections.

### SUMMARY

Allergies to food ingredients represent a loss of market share, and possibly liability, for food manufacturers. Allergies, or even mere sensitivities, to certain ingredients can cause a consumer to forego consumption of a food product to avoid the potential adverse reaction. By way of example, sensitivity to nuts, such as tree nuts (or their byproducts), legumes (such as peanuts), egg products (such as egg whites), or flour (e.g., those containing gluten) may prevent a consumer from consuming a food product made with one or more of those ingredients. By way of example, the classic French macarons are nearly always made based on almond flour, sugar and egg white, for flavor, texture and appearance purposes. The original recipe appears to have originated in Italy in the 8th century and later imported into France by the Queen. The presence of almond flour and egg whites limits the scope of consumers who can enjoy such a confection without the possibility of an adverse immune response. Thus, in conjunction with many establishments wishing to provide nut-free and/or gluten-free environments and product lines, provided for herein are confections (e.g., macarons) that are allergy-free and gluten-free.

In several embodiments, there is provided a confection comprising between about 15% and about 30% of grain-derived flour, between about 15% and about 30% of confectioner's sugar, between about 15% and about 30% of granulated sugar, between about 0.1% and about 3% of stem tuber-derived protein, and between about 0.005% and 0.9% of a polysaccharide-derived thickening agent, wherein the percentages of each ingredient are w/w.

In several embodiments, the confection is substantially free of tree nut allergens. In several embodiments, the confection is substantially free of other allergens directly or indirectly associated with tree nuts, such as peanuts or peanut butter that may be processed in a related facility and acts as a contaminant. In several embodiments, the confection is substantially free of egg product. In several embodiments, the confection is substantially free of ovalbumin. In several embodiments, the confection is substantially free of milk or dairy products. In several embodiments, the confection is substantially free of gluten.

In several embodiments, the grain-derived flour comprises oat flour. In several embodiments, the confection does note comprise almond flour.

In several embodiments, the grain-derived flour is derived from amaranth, barley, buckwheat, bulger, corn, einkorn, farro, fonio, freekeh, khorosan wheat, kaniwa, millet, quinoa, rice, rye, sorghum, spelt, teff, triticale, wheat, wild rice, or combinations thereof.

In several embodiments, the grain-derived flour is present in an amount between about 19% and about 25%. In several embodiments, the confectioner's sugar is present in an amount between about 19% and about 25%. In several embodiments, the confectioner's sugar optionally further comprises an anti-clumping agent selected from the group consisting of corn starch, potato starch, and tricalcium phosphate. In several embodiments, the granulated sugar is present in an amount between about 19% and about 25%. In several embodiments, one, or both, of the confectioner's sugar and the granulated sugar is derived from sugar cane. In several embodiments, the stem tuber-derived protein comprises potato protein. In several embodiments, the stem tuber-derived protein is present in an amount between about 0.5% and about 2%. In several embodiments, the polysaccharide-derived thickening agent comprises a starch, a fiber-based thickener, or a combination thereof. In those embodiments wherein the polysaccharide-derived thickening agent comprises a starch, the starch is selected from the group consisting of non-tree nut based flour, cornstarch, arrowroot, and tapioca. In those embodiments, wherein the polysaccharide-derived thickening agent comprises a fiber-based thickener, the fiber-based thickener is selected from the group consisting of xanthan gum, guar gum, pectin, and cellulose. In several embodiments, the polysaccharide-derived thickening agent is present in an amount between about 0.01% and about 0.5%.

In several embodiments, the confections provided for herein further comprise one or more of water, food coloring, and a flavoring agent. In several embodiments, the confections provided for herein further comprise water, food coloring, and a flavoring agent. In several embodiments, the food coloring comprises red and/or pink food coloring. In several embodiments, the food coloring is a combination of primary colors (e.g., red, blue and yellow). In several embodiments, the flavoring agent comprises a strawberry flavoring agent. In several embodiments, the confections provided for herein further comprise one or more of water, food coloring, and a flavoring agent, champagne, cognac, pectine (e.g., pectin NH), gelatin, citric acid, natural white wine flavor, and gold powder.

In several embodiments, the confections provided for herein are macaron cookies.

In several embodiments, there is provided a method for making a plurality of confections, the method comprising i) combining one part confectioner's sugar, one part grain-derived flour, and, optionally, between about 0.015-0.03 parts powdered flavoring agent, ii) processing the ingredients in i) to remove lumps, iii) mixing about 0.04-0.08 parts stem tuber-derived protein with about 0.7-0.9 parts water to generate a protein homogenate, iv) mixing about 50% of the protein homogenate with the processed ingredients from ii) to generate a dough, v) adding, optionally, a coloring agent or agents to the dough of iv) and further mixing to incorporate the color substantially uniformly, vi) dissolving 1 part granulated sugar in about 0.35-0.55 parts water and heating to between about 115-125 degrees Celsius to generate sugar syrup, vii) mixing the remaining ~50% of the protein homogenate with about 0.0005-0.0025 parts of a polysaccharide-derived thickening agent and mixing, viii) adding the heated sugar syrup to the whipped protein homogenate of vii) and mixing further to generate a protein meringue, ix) combining the dough of iv) with the protein meringue to generate a confectionary batter.

In several embodiments, the confectionary batter is substantially free of tree nut allergens. In several embodiments, the confectionary batter is substantially free of egg product. In several embodiments, the confectionary batter is substantially free of gluten. In several embodiments, the confectionary batter is substantially free of tree nut (or related contaminant) allergens and substantially free of egg product.

In several embodiments, the methods further comprise dividing the confectionary batter into a plurality of portions and placing at least a portion of the plurality of portions on a baking surface, such as a baking sheet or cookie sheet.

In several embodiments, the methods further comprise drying the plurality of portions on the baking surface for a period of time ranging from 5 minutes to 60 minutes. Drying is within ordinary skill in the confectionary arts and can be varied based on environmental conditions at a given location (e.g., ambient temperature and humidity varies with geography).

In several embodiments, the methods further comprise baking the plurality of portions on the baking surface. In several embodiments, the baking comprises baking the plurality of portions at a first temperature for a first period of time followed by a second temperature for a second period of time. In several embodiments, the first temperature is greater than the second temperature and the first time is less than the second time. In several embodiments, the first temperature ranges from 170-190 degrees Celsius and the second temperature ranges from 140-160 degrees Celsius. In several embodiments, the first period of time ranges from 1-5 minutes and the second period of time ranges from 15-25 minutes.

In several embodiments, the methods further comprise cooling the plurality of portions.

In several embodiments, the methods further comprise placing a filling between any two of the plurality of confectionary portions to generate a sandwich configuration. In several embodiments, the resulting cookie sandwich configuration is in the form of a macaron and is optionally further decorated with gold powder.

### BRIEF DESCRIPTION OF THE DRAWINGS

FIG. 1 schematically depicts a non-limiting example a process flow to prepare confection (e.g., macaron) shells for use in an allergen-free macaron.

### DETAILED DESCRIPTION

The following detailed description discusses non-limiting embodiments of allergen-free and/or gluten-free confections, such as a French macaron.

### Definitions

The following is a list of definitions for terms used herein. Unless defined otherwise, all technical terms used herein generally have the same meaning as commonly understood by one of ordinary skill in the art. In the event that there is a plurality of definitions for a term herein, those in this section prevail unless stated otherwise. Generally, the nomenclature used herein and the methods and procedures in the culinary arts are those well-known and commonly employed in the art.

As used herein, “about” will be understood by persons of ordinary skill in the art and will vary to some extent on the context in which it can be used. Generally, “about” encompasses a range of values that are plus/minus 10% of a reference value, unless specifically defined. For instance, “about 25%” encompasses values from 22.5% to 27.5%.

As used herein, “ambient conditions” means approximately room temperature (e.g., 20-35°C) and relative humidity of approximately <70%.

As used herein, “a reasonable period of time” means the time, ranging from months to years, depending upon the application, a composition may be expected to maintain a safe and efficacious amount of its combined ingredients.

As used herein, “shelf-life stable” and “shelf-life stability” are used interchangeably and refer to the multi-component composition being deemed consumer acceptable after a defined period of time after its production (under ambient conditions).

As used herein “a carrier” means those components of a composition that are capable of being commingled to provide required physical consistency and consumer goodness properties without interaction with other ingredients.

As used herein, “compatible” means that the components of the composition are capable of being commingled without interaction in any manner which would substantially adversely affect consumer perception of the qualities of the composition.

As used herein, “consumer goodness qualities” include, but are not limited to, appearance, viscosity, taste, odor, abrasiveness, color, flavor, and moisture content of the compositions deemed desirable by consumers through consumer product testing or other such means.

As used herein, “essentially free” means a composition which is comprised of very low levels, below detection levels of commonly used analytical methods, of a specific ingredient or compound or molecule.

As used herein, “essentially free of” means including unavoidable levels of a given material but no more.

As used herein, “substantially free of” means no more than 0.5% by weight of a given material.

As used herein, “range” means the area of variation between upper and lower limits on a particular scale. It is understood that any and all whole or partial integers between any ranges set forth herein are included herein.

As used herein, “shelf-life” means the length of time confections provided for herein maintain the desired consumer qualities of the confections. In several embodiments, the shelf life ranges from about 2 days to about 14 days when the confections are defrosted.

As used herein, “dispersing agent” means a compound that improves the separation of particles and prevents settling or clumping of an ingredient(s) in a multicomponent confection.

As used herein, “emollient agent” means a compound that reduces the loss of water from a confection.

As used herein, “suspending or emulsifying agent” means a compound that achieves uniform dispersion of an ingredient(s) in a multicomponent confection.

As used herein, “fragrance” means a compound that provides a pleasing scent or odor to a confection.

As used herein, “humectant” means a compound that preserves moisture in a confection. Some embodiments described herein include one or more compounds such as cellulose gum, carboxymethylcellulose, pectin, guar gum, xanthan gum, N-acyl sarcosinate, sodium lauroyl sarcosinate, sodium cocoyl sarcosinate, or sodium myristoyl sarcosinate.

As used herein, “thickener” means a compound that increases viscosity of all or part of a confection.

As used herein, “excipient” means a compound that provides physical and consumer goodness properties to a confection for its acceptance. Examples of such properties (including but not limited to) are viscosity, appearance, flavor, color, thickness, sweetness, texture, crispness, moisture, or combinations thereof.

All percentages and ratios used herein are by weight of a multi-component composition and not of the overall topical formulation that is delivered, unless otherwise specified. All measurements are made at room temperature i.e., 20-25°C, unless otherwise specified. Heat and humidity, under normal circumstances, may cause such a composition to degrade from liquid to gas, changing its weight and rendering common assay calculations inaccurate.

### Confectionary Ingredients

The confections provided for herein, and their related methods of preparation, include one, two, three, four or more of the following ingredient types. Specific examples of each type of ingredient serve as non-limiting embodiments. It shall be appreciated that listing of one specific ingredient under one category of ingredient does not preclude that from being included (e.g., functionally) in another category. By way of non-limiting example, a sweetening agent may also function as a thickening agent, and vice versa.

### Flour Base

In several embodiments, the confections provided for herein comprise at least one type of flour. In several embodiments, the flour is not derived from almonds. In several embodiments, the flour is not derived from tree nuts. In several embodiments, the flour is substantially free from, or free from, other allergens, such as peanut allergens. As a result, in several embodiments, the confections provided for herein, such as macarons, are substantially free of tree nut and/or almond allergens. In several embodiments, the flour used in the provided confections is derived from a grain. In several embodiments, the flour is obtained from milling or otherwise grinding one or more of the following grains: amaranth, barley, buckwheat, bulger, corn, einkorn, farro, fonio, freekeh, khorosan wheat, kaniwa, millet, oats, quinoa, rice, rye, sunflower seed, sorghum, spelt, teff, triticale, wheat, or wild rice. In several embodiments, the flour is oat flour. Advantageously, in several embodiments, the confections are thus not only free of tree nut allergens (and/or egg product allergens, as discussed below), but are also gluten-free.

In several embodiments, the flour is provided in an amount ranging from about 15% to about 30% (on a weight/weight basis) of the total weight of the batter to create the confections, including about 15%, about 16%, about 17%, about 18%, about 19%, about 20%, about 21%, about 22%, about 23%, about 24%, about 25%, about 26%, about 27%, about 28%, about 29%, about 30%, or any percentage between those listed.

### Sweetening Agent

In several embodiments, the confections provided for herein comprise at least one type of sweetening agent. In several embodiments, the sweetening agent comprises confectioner's sugar (powdered sugar plus cornstarch to prevent clumping). In several embodiments, the sweetening agent comprises powdered sugar. In several embodiments, any of the granulated sugars listed herein can be further ground or processed to yield a powdered sugar substitute.

In several embodiments, the confectioner's or powdered sugar is provided in an amount ranging from about 15% to about 30% (on a weight/weight basis) of the total weight of the batter to create the confections, including about 15%, about 16%, about 17%, about 18%, about 19%, about 20%, about 21%, about 22%, about 23%, about 24%, about 25%, about 26%, about 27%, about 28%, about 29%, about 30%, or any percentage between those listed.

In several embodiments, the confectionaries provided for herein also comprises granulated sugar, such as granulated cane sugar. In several embodiments, alternatives to granulated sugar include, but are not limited to by way of non-limiting example, light or dark brown sugar, allulose, erythriol, xylitol, demerara sugar, turbinado sugar, coconut sugar, stevia, honey, maple syrup, agave nectar, molasses, and/or monk fruit sweetener. In several embodiments, the granulated sugar is derived from sugar cane.

In several embodiments, the granulated sugar is provided in an amount ranging from about 15% to about 30% (on a weight/weight basis) of the total weight of the batter to create the confections, including about 15%, about 16%, about 17%, about 18%, about 19%, about 20%, about 21%, about 22%, about 23%, about 24%, about 25%, about 26%, about 27%, about 28%, about 29%, about 30%, or any percentage between those listed.

### Thickening Agent

In several embodiments, the confections provided for herein comprise at least one thickening agent. In several embodiments, the flour(s) disclosed herein can also function as a thickening agent. In several embodiments, the thickening agent comprises a polysaccharide-derived agent. In several embodiments, the thickening agent comprises a starch, a fiber-based thickener, or a combination thereof. In several embodiments, the polysaccharide-derived thickening agent comprises a starch selected from the group consisting of non-tree nut based flour, cornstarch, arrowroot, and tapioca. In several embodiments, the polysaccharide-derived thickening agent comprises a fiber-based thickener selected from the group consisting of xanthan gum, guar gum, pectin, and cellulose. In several embodiments, the thickening agent comprises xanthan gum. In several embodiments, the thickening agent comprises psyllium husk, chia seeds, ground flax seeds, cornstarch, gelatin, agar agar, konjac powder, or combinations thereof.

In several embodiments, the thickening agent(s) is provided in an amount ranging from about 0.005% to about 3% (on a weight/weight basis) of the total weight of the batter to create the confections, including about 0.005%, about 0.0075%, about 0.01%, about 0.02%, about 0.03%, about 0.04%, about 0.05%, about 0.06%, about 0.07%, about 0.08%, about 0.09%, about 0.1%, about 0.2%, about 0.3%, about 0.4%, about 0.5%, about 0.6%, about 0.7%, about 0.8%, about 0.9%, about 1.0%, about 1.5%, about 2.0%, about 2.5%, about 3.0%, or any percentage between those listed.

### Foaming Agent

In several embodiments, the confections provided for herein comprise at least one type of sweetening agent. As discussed herein, in several embodiments, the foaming agents are used to reduce or eliminate the egg whites typically used in preparing macarons and other such meringue-based confections. In several embodiments, the removal of egg whites, or reduction of the amount of egg white used, allows for individuals with sensitivity or allergies to eggs to consume the confections with reduced risk of adverse immune response. In several embodiments, the reduction in egg white amount is at least 50%, at least 75%, at least 85% or complete removal of egg whites. In several embodiments, in place of egg whites, there is used a stem tuber-derived protein. In several embodiments, the protein is derived from potato, yam, sweet potato, cassava, or dahlia. In several embodiments, the protein is derived from potato. In several embodiments, whipped chickpea brine (also known as aquafaba) is used as a foaming agent. In several embodiments, a foaming agent the is a combination of waxy corn starch and super-whipping albumins (Spuma Mix from decorfood, Italy) is used. In several embodiments, a foaming agent the is based on hydrolysed milk proteins (Hyfoama from Kerry Group, USA) is used. In several embodiments, one or more of soy lecithin, quillaja extract (from the soapbark tree), and various plant-based proteins like pea protein or lentil protein are used as foaming agents.

In several embodiments, the foaming agent(s) is provided in an amount ranging from about 0.05% to about 3% (on a weight/weight basis) of the total weight of the batter to create the confections, including about 0.05%, about 0.075%, about 0.1%, about 0.5%, about 1.0%, about 1.2%, about 1.3%, about 1.4%, about 1.5%, about 1.6%, about 1.7%, about 1.8%, about 1.9%, about 2.0%, about 2.25%, about 2.5%, about 2.75%, about 3.0%, or any percentage between those listed.

### Solvent

In several embodiments, the dry ingredients provided for herein are mixed with a solvent. In several embodiments, the solvent comprises water. At least a portion of the water could be replaced with another solvent, such as milk, buttermilk, fruit juice, coffee, tea, whey, beer, wine, and/or flavored water. In several embodiments, the solvent, such as water, can be divided into portions used to independently make different parts of the confection batter. For example, in several embodiments, a first amount of water (or other solvent) is used to create a dough by mixing with at least a portion the flour and sweetening agent. In several embodiments, a second portion of the solvent (e.g., water) is used to create aa syrup with the sweetening agent(s). In several embodiments, a solvent (e.g., water) is provided in an amount ranging from about 6% to about 36% (on a weight/weight basis) of the total weight of the batter to create the confections, including about 6%, about 8%, about 10%, about 12%, about 14%, about 16%, about 18%, about 20%, about 22%, about 24%, about 26%, about 28%, about 30%, about 32%, about 34%, about 26%, or any percentage between those listed.

### Coloring Agent

Depending on the embodiment, the confections provided for herein are optionally produced in a variety of colors. Depending on the embodiments, confections provided for herein range in color from pale pastels to bold hues such as pink, yellow, green, blue, and purple, among others. The colors are achieved through the use of food coloring. A variety of food coloring agents are contemplated herein, including but not limited to gel, liquid, powder, or natural coloring agents. In several embodiments, gel coloring agents comprise a synthetic color and corn syrup (or glycerin) as a base. In several embodiments, liquid coloring agents comprise a synthetic color and water as a base. In several embodiments, the coloring agent is a synthetic dye in powder form. In several embodiments, natural food coloring agents include, for example, powders derived from brightly colored fruits or vegetables, such as turmeric powder, hibiscus powder, beet root powder, and the like. In several embodiments, the coloring agent is a gel format. In several embodiments, the coloring agent is a powder format. In several embodiments, the coloring agent is red, yellow, blue, violet, pink, royal blue, teal, sky blue, red, black, egg yellow, lemon yellow, mauve, burgundy, dusty rose, or combinations thereof. It shall be appreciated that, though the use of the primary colors, numerous hues can be generated and used to color the confections provided for herein.

In several embodiments, a coloring agent(s) is provided in an amount ranging from about 0.005% to about 3% (on a weight/weight basis) of the total weight of the batter to create the confections, including about 0.005%, about 0.0075%, about 0.01%, about 0.02%, about 0.03%, about 0.04%, about 0.05%, about 0.06%, about 0.08%, about 0.1%, about 0.5%, about 1.0%, about 1.5%, about 2.0%, about 2.5%, about 3.0%, or any percentage between those listed.

### Flavoring Agent

Depending on the embodiment, the confections provided for herein are optionally produced in a variety of flavors. In several embodiments, the confections are strawberry flavored. In several embodiments, the confections are vanilla flavored. In several embodiments, the confections are chocolate flavored. In several embodiments, the confections provided for here are produced with one (or more) of the following flavors: lavender, caramel, raspberry, lemon, pistachio, almond (flavor, but without almond allergens), salted caramel, butter cake, pumpkin spice, white chocolate, blackberry, chocolate peanut butter, crème brulee, donut, honey orange, milk chocolate, milk chocolate miso, dulce du leche, cherry, espresso, Earl Grey, apple pie, s'mores, fig and cardamom, champagne, peppermint, banana pudding, toasted coconut, or combinations thereof.

In several embodiments, a favoring agent(s) is provided in an amount ranging from about 0.05% to about 3% (on a weight/weight basis) of the total weight of the batter to create the confections, including about 0.05%, about 0.075%, about 0.1%, about 0.2%, about 0.3%, about 0.4%, about 0.5%, about 0.6%, about 0.7%, about 0.8%, about 0.9%, about 1.0%, about 1.5%, about 2.0%, about 2.5%, about 3.0%, or any percentage between those listed.

### EXAMPLES

The following examples represent non-limiting embodiments of confectionary compositions and related preparation methods.

### Example 1—Preparation of Allergen-free Macaron Confections

Provided herein is a non-limited process for the production of allergen-free macaron shells.

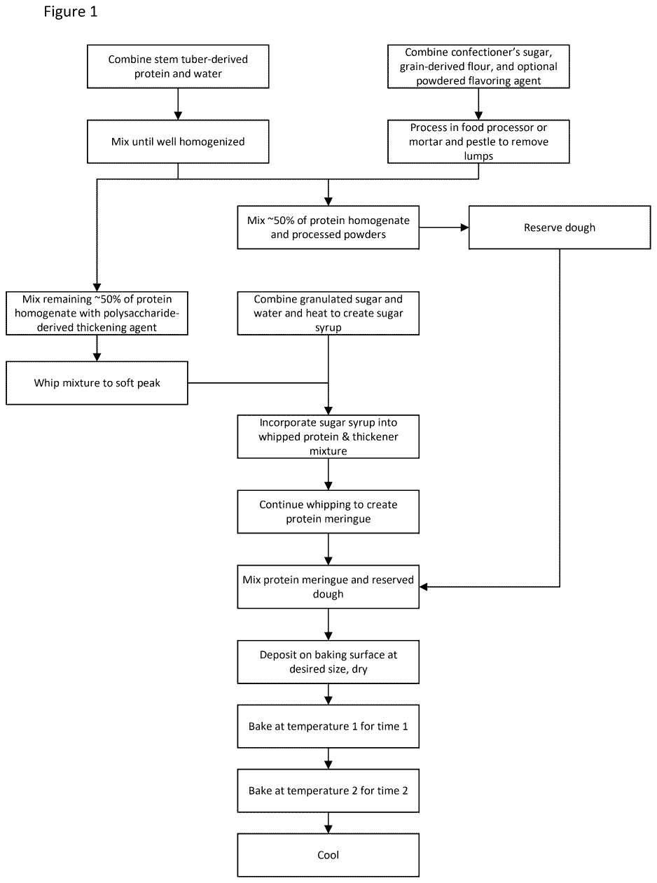

As depicted in the flowchart of FIG. 1, water (as solvent) is mixed with a stem-tuber derived protein, such as potato protein. In this non-limiting embodiment, about 0.04-0.08 parts (e.g., ~0.06 parts) potato protein with about 0.7-0.9 parts (e.g., ~0.8 parts) water to generate a protein homogenate. The protein powder was mixed with the water until uniform and well homogenized mixture was achieved.

Separately, confectioner's sugar (1 part), grain-derived flour (1 part, here, oat flour as a non-limiting example) and powdered flavorant (here, about 0.025 parts strawberry as a non-limiting example) were combined and then processed in a food processor to remove any lumps. As disclosed herein, other processing methods (e.g., sifting or sieving, or mortar and pestle) could also be used. Additionally, use of a flavoring agent is optional, as the process provided in this example is for making the shells of the macaron, and flavoring could be provided via the filling alone.

Approximately 50% of the potato protein homogenate and the processed dry ingredients (confectioner's sugar, oat flour, and flavorant) are mixed, for example with a mixer equipped with a paddle attachment (though mixing can be performed by hand). Mixing was performed for ~2 minutes followed by addition of a combination of red food coloring and pink food coloring (0.0015 parts and 0.000233 parts, respectively, as an example). The mixture was mixed for an additional ~2 minutes and reserved for use later in the process.

About 0.3-0.5 parts (e.g., ~0.44 parts) water was heated and 1 part granulated sugar was added and heated to ~118-122 degree Celsius to form sugar syrup. As that temperature was reached, in a separate vessel, the remaining ~50% of the potato protein homogenate was whipped (mixing machine with whip attachment, though whipping by hand can be performed) with about 0.001-0.002 parts (e.g., ~0.0013 parts) of a polysaccharide-derived thickening agent. In this non-limiting example, xanthan gum was used. This mixture was whipped until soft peaks were formed (by soft peaks, it is meant forms soft, slightly pointed peaks that rapidly fall over when lifted, indicating that it has thickened but is not yet fully stiff), taking ~2 minutes at a high speed.

Upon reaching ~118-122 degree Celsius, the sugar syrup was slowly added into the whipped potato protein mixture (slow enough to avoid coagulation of the potato protein) and mixed at medium-high speed. After the syrup was fully incorporated the mixer speed was increased to high (using the whisk attachment) and the mixture was whipped for an additional ~6 min to form whipped potato protein meringue (with stiff peaks).

To this whipped potato protein meringue, the reserved dough was added and mixed at medium low speed with the paddle attachment for ~30 second to yield the macaron shell batter.

The batter was added to a piping machine and piped onto flat sheetpans covered with Teflon sheets to avoid sticking. These piped shells were allowed to dry for ~15 minutes with ventilation, though the time and/or ventilation will vary depending on local conditions (e.g., humidity and temperature). The macaron shells were placed in a preheated over (180 degrees Celsius) and baked for ~3 min, followed by ~18 minutes at 150 degrees Celsius. The macaron shells were then cooled.

The shells exhibited a flavor profile substantially consistent with traditional strawberry macaron shells (almond flour-based with egg whites). The shells were not cracked or brittle and exhibited a mouth feel and texture consistent with traditional macaron shells, but without allergens such as tree nut flour or egg whites and without gluten.

The macaron shells were used to generate sandwich style strawberry macarons (with a traditional strawberry filling) that have a shelf life of ~6 days when defrosted. This example thus demonstrates that alternative ingredients can be used to produce allergen-free and gluten-free confections, such as a French macaron, and can advantageously be produced at lower overall price points, with increased potential consumer base.

It is contemplated that various combinations or subcombinations of the specific features and aspects of the embodiments disclosed above may be made and still fall within one or more of the inventions. Further, the disclosure herein of any particular feature, aspect, method, property, characteristic, quality, attribute, element, or the like in connection with an embodiment can be used in all other embodiments set forth herein. Accordingly, it should be understood that various features and aspects of the disclosed embodiments can be combined with or substituted for one another in order to form varying modes of the disclosed inventions. Thus, it is intended that the scope of the present inventions herein disclosed should not be limited by the particular disclosed embodiments described above. Moreover, while the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents, and alternatives falling within the spirit and scope of the various embodiments described and the appended claims. Any methods disclosed herein need not be performed in the order recited. The methods disclosed herein include certain actions taken by a practitioner; however, they can also include any third-party instruction of those actions, either expressly or by implication. In addition, where features or aspects of the disclosure are described in terms of Markush groups, those skilled in the art will recognize that the disclosure is also thereby described in terms of any individual member or subgroup of members of the Markush group.

All references cited herein, including but not limited to published and unpublished applications, patents, and literature references, are incorporated herein by reference in their entirety and are hereby made a part of this specification. To the extent publications and patents or patent applications incorporated by reference contradict the disclosure contained in the specification, the specification is intended to supersede and/or take precedence over any such contradictory material.

Where percentages are provided for agents, ingredients, and compounds, they can be % m/m, % m/w, % w/w, % m/v, % v/v and variations thereof with respect to the formulation as a whole, unless otherwise indicated.

The use of agents, ingredients and compounds may be used interchangeably herein. In several embodiments, reference to the term “based” includes the recited agent, ingredient or compounds. As used herein, the terms composition and formulation can be used interchangeably. Salt forms of the acids identified herein may be used instead of or in addition to the acid.

With respect to the use of plural and/or singular terms herein, those having skill in the art can translate from the plural to the singular and/or from the singular to the plural as is appropriate to the context and/or application.

As will be understood by one skilled in the art, for any and all purposes, such as in terms of providing a written description, all ranges disclosed herein also encompass any and sub-ranges and combinations of sub-ranges thereof. As will also be understood by one skilled in the art all language such as “up to,” “at least,” “greater than,” “less than,” and the like include the number recited and refer to ranges which can be subsequently broken down into sub-ranges as discussed above. Finally, as will be understood by one skilled in the art, a range includes each individual member. Thus, for example, a group having 1-3 articles refers to groups having 1, 2, or 3 articles. Similarly, a group having 1-5 articles refers to groups having 1, 2, 3, 4, or 5 articles, and so forth. The phrases “and ranges in between” can include ranges that fall in between the numerical values listed. For example, “1, 2, 3, 10, and ranges in between” can include 1-10, 1-3, 2-10, etc.

While various aspects and embodiments have been disclosed herein, other aspects and embodiments will be apparent to those skilled in the art. The various aspects and embodiments disclosed herein are for purposes of illustration and are not intended to be limiting, with the scope and spirit being indicated by, for example, the following claims.

1. A confection comprising:
between about 15% and about 30% of grain-derived flour;
between about 15% and about 30% of confectioner's sugar;
between about 15% and about 30% of granulated sugar;
between about 0.1% and about 3% of stem tuber-derived protein; and
between about 0.005% and 0.9% of a polysaccharide-derived thickening agent,
wherein the percentages of each ingredient are w/w, and
wherein the confection is substantially free of tree nut allergens.

2. The confection
wherein the confection is further substantially free of egg product and/or wherein the confection is further substantially free of gluten.

3. (canceled)

4. The confection of claim 1, wherein the grain-derived flour comprises oat flour, or wherein the grain-derived flour is derived from amaranth, barley, buckwheat, bulger, corn, einkorn, farro, fonio, freekeh, khorosan wheat, kaniwa, millet, quinoa, rice, rye, sorghum, spelt, teff, triticale, wheat, or wild rice.

5. (canceled)

6. The confection of claim 1, wherein the confection does not comprise almond flour.

7. The confection of claim 1, wherein one or more of the grain-derived flour, the confectioner's sugar, and the granulated sugar is present in an amount between about 19% and about 25%.

8. (canceled)

9. The confection of claim 7, wherein the confectioner's sugar further comprises an anti-clumping agent selected from the group consisting of corn starch, potato starch, and tricalcium phosphate and wherein one or both of the confectioner's sugar and the granulated sugar is derived from sugar cane.

10. (canceled)

11. (canceled)

12. The confection of claim 1, wherein the stem tuber-derived protein comprises potato protein, and wherein the stem tuber-derived protein is present in an amount between about 0.5% and about 2%.

13. (canceled)

14. The confection of claim 1, wherein the polysaccharide-derived thickening agent comprises a starch, a fiber-based thickener, or a combination thereof.

15. The confection of claim 14, wherein the polysaccharide-derived thickening agent comprises a starch, wherein the starch is selected from the group consisting of non-tree nut based flour, cornstarch, arrowroot, and tapioca.

16. (canceled)

17. The confection of claim 14, wherein the polysaccharide-derived thickening agent comprises a fiber-based thickener, wherein the fiber-based thickener is selected from the group consisting of xanthan gum, guar gum, pectin, and cellulose.

18. (canceled)

19. The confection of claim 1, wherein the polysaccharide-derived thickening agent is present in an amount between about 0.01% and about 0.5%.

20. The confection of claim 1, further comprising one or more of water, food coloring, and a flavoring agent, wherien the food coloring comprises red and/or pink food coloring and wherein the flavoring agent comprises a strawberry flavoring agent.

21. (canceled)

22. (canceled)

23. (canceled)

24. The confection of claim 1, further comprising one or more of water, food coloring, and a flavoring agent, champagne, cognac, pectine (e.g., pectin NH), gelatin, citric acid, natural white wine flavor, and gold powder.

25. A method for making a plurality of confections, the method comprising:
i) combining one part confectioner's sugar, one part grain-derived flour, and, optionally, between about 0.015-0.03 parts powdered flavoring agent;
ii) processing the ingredients in i) to remove lumps;
iii) mixing about 0.04-0.08 parts stem tuber-derived protein with about 0.7-0.9 parts water to generate a protein homogenate;
iv) mixing about 50% of the protein homogenate with the processed ingredients from ii) to generate a dough;
v) adding, optionally, a coloring agent or agents to the dough of iv) and further mixing to incorporate the color substantially uniformly;
vi) dissolving 1 part granulated sugar in about 0.35-0.55 parts water and heating to between about 115-125 degrees Celsius to generate sugar syrup;
vii) mixing the remaining ~50% of the protein homogenate with about 0.0005-0.0025 parts of a polysaccharide-derived thickening agent and mixing;
viii) adding the heated sugar syrup to the whipped protein homogenate of vii) and mixing further to generate a protein meringue;
ix) combining the dough of iv) with the protein meringue to generate a confectionary batter,
wherein a) wherein the confectionary batter is substantially free of tree nut allergens, b) the confectionary batter is substantially free of egg product, c) the confectionary batter is substantially free of gluten, or d) the confectionary batter is substantially free of tree nut allergens, substantially free of egg product, and substantially free of gluten,

26. The method of claim 25, further comprising dividing the confectionary batter into a plurality of portions and placing at least a portion of the plurality of portions on a baking surface.

27. The method of claim 26, further comprising drying the plurality of portions on the baking surface for a period of time ranging from 5 minutes to 60 minutes and further comprising baking the plurality of portions on the baking surface.

28. (canceled)

29. The method of claim 28, wherein the baking comprises baking the plurality of portions at a first temperature for a first period of time followed by a second temperature for a second period of time and wherein the first temperature is greater than the second temperature and the first time is less than the second time.

30. (canceled)

31. The method of claim 29, wherein the first temperature ranges from 170-190 degrees Celsius and the second temperature ranges from 140-160 degrees Celsius, and wherein the first period of time ranges from 1-5 minutes and the second period of time ranges from 15-25 minutes.

32. (canceled)

33. The method of claim 31, further comprising cooling the plurality of portions.

34. The method of claim 33, further comprising placing a filling between any two of the plurality of confectionary portions to generate a sandwich configuration, and wherein the resulting sandwich configuration is in the form of a macaron and is optionally further decorated with gold powder.

35. (canceled)
